(19) United States
(12) Patent Application Publication
(10) Pub. No.: US 2016/0016411 A1
(43) Pub. Date: Jan. 21, 2016

(54) Liquid Container

(71) Applicant: Seiko Epson Corporation, Tokyo (JP)

(72) Inventors: Hiroyuki Kawate, Hokuto-shi (JP); Taku Ishizawa, Matsumoto-shi (JP)

(21) Appl. No.: 14/799,932

(22) Filed: Jul. 15, 2015

(30) Foreign Application Priority Data
Jul. 18, 2014 (JP) 2014-147473

(51) Int. Cl. B41J 2/175

(52) U.S. Cl. CPC B41J 2/17553

(57) ABSTRACT

In order to set preferred dimensions of a liquid container, the invention provides an ink container including: an ink bag that includes at least two flexible film sheets bonded in a mutually facing relationship and can contain ink between the at least two film sheets; and a handle portion that is positioned at an end portion of the ink bag and protrudes outward from the ink bag, wherein the handle portion includes an opening formed so as to pass through in a first direction that is a direction in which the at least two film sheets face each other, the opening has an opening dimension W1 in a third direction K3 within a range from 80 mm to 120 mm, and the ink bag has a width dimension W2 in the third direction K3 within a range from 50 mm to 300 mm.

### BACKGROUND

1. Technical Field

The present invention relates to a liquid container or the like.

2. Related Art

Ink jet printers have long been known as an example of liquid ejection apparatuses. Ordinary inkjet printers eject ink from their print head toward a print receiving medium, such as paper, so as to perform printing on the print receiving medium. In order to stably supply ink to the print head, it is known that such ordinary printers are configured to be connected to an external ink supply apparatus (liquid supply apparatus) (see, for example, JP-A-2009-202346).

With an external ink supply apparatus according to JP-A-2009-202346 mentioned above, the ink contained in an ink pack, which is an example of a liquid container, is supplied to the print head via an ink tube. The external ink supply apparatus can thereby stably supply ink to the print head. However, with the external ink supply apparatus, from the viewpoint of ease of handling, convenience of utilization and the like of the ink pack, it is necessary to set preferred dimensions for the ink pack. However, JP-A-2009-202346 mentioned above does not disclose the dimensions of the ink pack.

### SUMMARY

An advantage of some aspects of the invention is to solve at least the above-described problem, and can be implemented as embodiments or application examples described below.

### APPLICATION EXAMPLE 1

A first aspect of the invention provides a liquid container that is capable of being attached to and detached from a liquid supply apparatus that supplies a liquid to a liquid ejection apparatus, the liquid container including: a liquid containing portion that includes at least two flexible film sheets bonded in a mutually facing relationship and can contain a liquid between the at least two film sheets; and a handle portion that is positioned at an end portion of the liquid containing portion and protrudes outward from the liquid containing portion, wherein the handle portion includes an opening formed so as to pass through in a first direction that is a direction in which the at least two film sheets face each other, in a third direction that is a direction that crosses the first direction and a second direction that is a direction in which the handle portion protrudes outward from the liquid containing portion, the opening has a dimension within a range from 80 mm to 120 mm, and the liquid containing portion has a width dimension in the third direction within a range from 50 mm to 300 mm.

The liquid container according to this application example provides ease of handling because the liquid container can be easily carried by holding the handle portion by inserting the fingers into the opening of the handle portion. Also, in the liquid container, the dimension in the third direction of the opening of the handle portion is within a range from 80 mm to 120 mm. If the opening dimension is within this range, the fingers can be easily inserted into the opening of the handle portion. If the opening dimension is below that range, it becomes difficult to insert the fingers into the opening. If the opening dimension is above that range, the holding position easily varies significantly. Also, in the liquid container, the width dimension in the third direction of the liquid containing portion is within a range from 50 mm to 300 mm. If the width dimension is within this range, deformation of the liquid containing portion can be reduced without significantly compromising the volume efficiency of the liquid containing portion. If the width dimension is below the range, the volume efficiency of the liquid containing portion is likely to be low. If the width dimension is above the range, for example, in the case where the handle portion is held so as to lift the liquid container, the liquid containing portion is likely to undergo deformation.

### APPLICATION EXAMPLE 2

A second aspect of the invention provides a liquid container that is capable of being attached to and detached from a liquid supply apparatus that supplies a liquid to a liquid ejection apparatus, the liquid container including: a liquid containing portion that includes at least two flexible film sheets bonded in a mutually facing relationship and can contain a liquid between the at least two film sheets; and a handle portion that is positioned at an end portion of the liquid containing portion and protrudes outward from the liquid containing portion, wherein in a second direction that is a direction in which the handle portion protrudes outward from the liquid containing portion, a dimension including the liquid containing portion and the handle portion is within a range from 50 mm to 400 mm.

The liquid container according to this application example provides ease of handling because the liquid container can be easily carried by holding the handle portion. Also, in the liquid container, the dimension in the second direction including the liquid containing portion and the handle portion is within a range from 50 mm to 400 mm. If the dimension is within this range, the liquid container can be easily handled. If the dimension is below the range, the amount of liquid that can be contained in the liquid container decreases. If, on the other hand, the dimension is above the range, for example, in the case where the handle portion is held so as to lift the liquid container from the floor, it becomes difficult to handle the liquid container because the liquid container is suspended closer to the floor. Also, the liquid supply apparatus is likely to be large if the dimension is above the range.

### APPLICATION EXAMPLE 3

A third aspect of the invention provides a liquid container that is capable of being attached to and detached from a liquid supply apparatus that supplies a liquid to a liquid ejection apparatus, the liquid container including: a liquid containing portion that includes at least two flexible film sheets bonded in a mutually facing relationship and can contain a liquid between the at least two film sheets; and a handle portion that is positioned at an end portion of the liquid containing portion and protrudes outward from the liquid containing portion, wherein when a direction in which the at least two film sheets face each other is defined as a first direction, in a state in which the liquid containing portion contains a liquid, a distance in the first direction between the at least two film sheets of a maximally expanded portion of the liquid containing portion is within a range from 10 mm to 150 mm.

The liquid container according to this application example provides ease of handling because the liquid container can be easily carried by holding the handle portion. Also, in the liquid container, the distance in the first direction between the two film sheets is within a range from 10 mm to 150 mm. If the distance is within this range, the liquid contained in liquid containing portion can be effectively used without significantly compromising the volume efficiency of the liquid containing portion. If the distance is below the range, the volume efficiency of the liquid containing portion is likely to be low. If the distance is above the range, any unused liquid that is not supplied (fails to be supplied) when the liquid contained in the liquid container is supplied to the liquid ejection apparatus after the liquid container is attached to the liquid supply apparatus is likely to remain in the liquid containing portion. As a result, it becomes difficult to increase the amount of liquid contained in the liquid containing portion that can be effectively used.

### APPLICATION EXAMPLE 4

A fourth aspect of the invention provides any one of the liquid containers described above, wherein the film sheets have a thickness within a range from 0.05 mm to 0.5 mm.

According to this application example, the film sheets have a thickness within a range from 0.05 mm to 0.5 mm, and thus the volume of liquid contained in the liquid containing portion can be easily ensured without compromising the strength of the liquid containing portion. If the thickness is below the range, the strength of the liquid containing portion is likely to be low. If the thickness is above the range, the flexibility of the liquid containing portion is likely to be low, and the liquid containing portion is less likely to expand, as a result of which the volume of liquid contained in the liquid containing portion is likely to be low.

### BRIEF DESCRIPTION OF THE DRAWINGS

The invention will be described with reference to the accompanying drawings, wherein like numbers reference like elements.

FIG. 1 is a perspective view showing the main components of a printer according to an embodiment of the invention.

FIG. 2 is a perspective view of an ink container according to the embodiment of the invention.

FIG. 3 is a perspective view of an ink container according to the embodiment of the invention.

FIG. 4 is a perspective view of an ink container according to the embodiment of the invention.

FIG. 5 is a perspective view of an ink container according to the embodiment of the invention.

FIG. 6 is a perspective view of an ink container according to the embodiment of the invention.

FIG. 7 is a perspective view of an ink container according to the embodiment of the invention.

FIG. 8 is an exploded perspective view of an ink container according to the embodiment of the invention.

FIG. 9 is an exploded perspective view showing a flow path unit according to the embodiment of the invention.

FIG. 10 is a cross-sectional view of a flow path member according to the embodiment of the invention, taken along the line A-A shown in FIG. 9.

FIG. 11 is an enlarged cross-sectional view of the flow path unit according to the embodiment of the invention, taken along the line A-A shown in FIG. 9.

FIG. 12 is an enlarged cross-sectional view of the flow path unit according to the embodiment of the invention, taken along the line A-A shown in FIG. 9.

FIG. 13 is a perspective view of the flow path member according to the embodiment of the invention.

FIG. 14 is a front view of an ink container according to the embodiment of the invention.

FIG. 15 is a side view of the ink container according to the embodiment of the invention.

### DESCRIPTION OF EXEMPLARY EMBODIMENTS

An embodiment of the invention will be described with reference to the drawings by taking a liquid ejection system as an example. In the drawings, components and members may be shown in different scales and sizes in order to enhance visual recognition of each configuration.

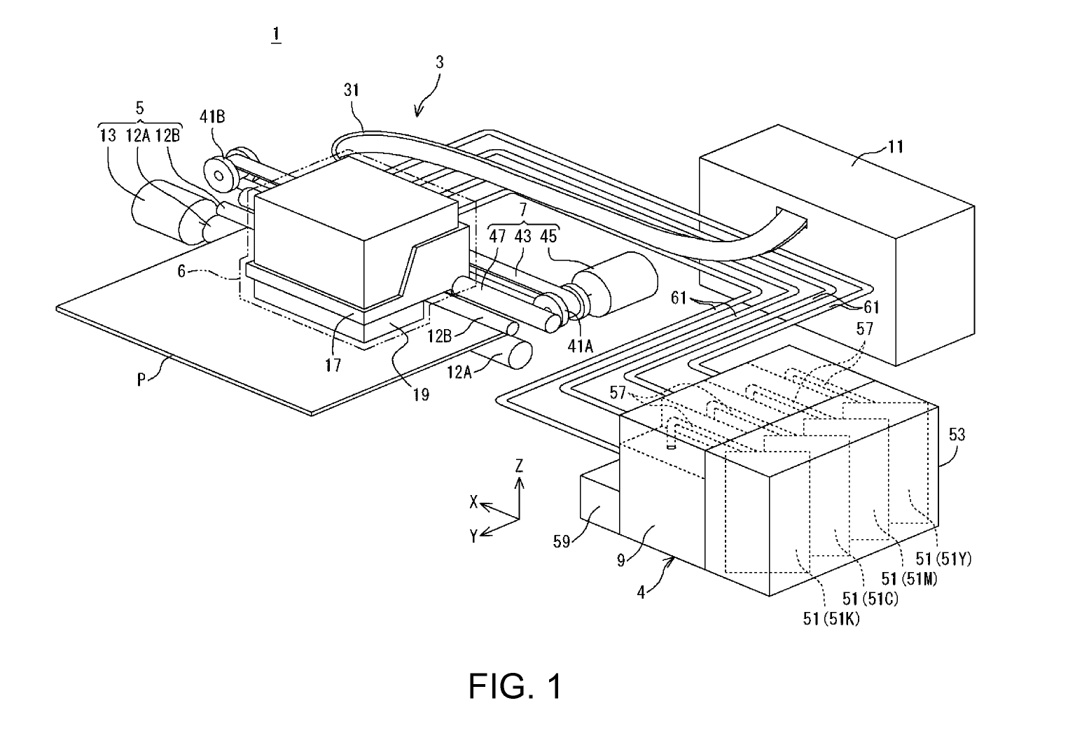

As shown in FIG. 1, a liquid ejection system 1 according to the embodiment of the invention includes a printer 3, which is an example of a liquid ejection apparatus, and an ink supply apparatus 4, which is an example of a liquid supply apparatus. The printer 3 includes a conveyance apparatus 5, a recording portion 6, a moving apparatus 7, a relay apparatus 9, and a control portion 11. Note that in FIG. 1, X, Y and Z axes are shown as mutually perpendicular coordinate axes. The subsequent drawings also show X, Y and Z axes as appropriate. In the present embodiment, the liquid ejection system 1 is used in a state in which the liquid ejection system 1 is disposed on a horizontal plane (X-Y plane) defined by the X axis and the Y axis. The Z axis is an axis perpendicular to the horizontal plane. In the state in which the liquid ejection system 1 is used, +Z axis direction serves as the vertically upward direction. In addition, in the state in which the liquid ejection system 1 is used, as shown in FIG. 1, −Z axis direction serves as the vertically downward direction. The pointing direction of the arrows of the X, Y and Z axes indicates the positive (+) direction, and the direction opposite to the pointing direction of the arrows indicates the negative (−) direction.

The conveyance apparatus 5 intermittently conveys a recording medium P such as recording paper in the Y axis direction. The recording portion 6 performs recording on the recording medium P conveyed by the conveyance apparatus 5 with the use of ink, which is an example of a liquid. The moving apparatus 7 moves the recording portion 6 in a reciprocal manner along the X axis. The ink supply apparatus 4 supplies ink to the recording portion 6 via the relay apparatus 9. The relay apparatus 9, which is provided between the ink supply apparatus 4 and the recording portion 6, relays the ink from the ink supply apparatus 4 to the recording portion 6. The control portion 11 controls the driving of the components described above.

As shown in FIG. 1, the conveyance apparatus 5 includes a drive roller 12A, a driven roller 12B, and a conveyance motor 13. The drive roller 12A and the driven roller 12B are configured to be capable of rotation, with their outer circumferences contacting each other. The conveyance motor 13 generates motive power for rotationally driving the drive roller 12A. The motive power from the conveyance motor 13 is transmitted to the drive roller 12A via a power transmission mechanism. Then, the recording medium P sandwiched between the drive roller 12A and the driven roller 12B is intermittently conveyed in the Y axis direction.

The recording portion 6 includes a carriage 17 and a recording head 19. The recording head 19 discharges ink as ink droplets so as to perform recording on the recording medium P. The carriage 17 includes the recording head 19. The recording head 19 is connected to the control portion 11 via a flexible cable 31. The discharge of ink droplets from the recording head 19 is controlled by the control portion 11.

As shown in FIG. 1, the moving apparatus 7 includes a timing belt 43, a carriage motor 45, and a guide shaft 47. The timing belt 43 is held under tension between a pair of pulleys 41A and 41B. The pair of pulleys 41A and 41B are aligned along the X axis. The timing belt 43 is thus held under tension along the X axis. The carriage motor 45 generates motive power for rotationally driving the pulley 41A. The guide shaft 47 extends along the X axis. The opposite ends of the guide shaft 47 are supported by a casing (not shown), and guides the carriage 17 along the X axis.

The carriage 17 is fixed to a part of the timing belt 43. The carriage 17 receives the motive power transmitted from the carriage motor 45 via the pulley 41A and the timing belt 43. Then, the carriage 17 is moved in a reciprocal manner along the X axis by the motive power transmitted to the carriage 17.

As shown in FIG. 1, the ink supply apparatus 4 includes an ink container 51, which is an example of a liquid container, and a case 53. In the present embodiment, the ink supply apparatus 4 includes a plurality of (four in the present embodiment) ink containers 51. The four ink containers 51 are contained in the case 53. The four ink containers 51 contain mutually different types of ink. In the present embodiment, yellow (Y) ink, magenta (M) ink, cyan (C) ink and black (K) ink are contained respectively in the ink containers 51. The case 53 is provided with a detachable unit (not shown) for supporting the ink containers 51. The four ink containers 51 are supported so as to be capable of being attached to and detached from the detachable unit. Each ink container 51 has an ink bag serving as a liquid containing portion. Ink is hermetically sealed in the ink bag made of a flexible sheet. With the liquid ejection system 1, an ink bag whose ink is used up is replaced with a new ink container 51.

An ink supply tube 57 is connected to the ink bag of each ink container 51 via the detachable unit (not shown). The ink supply tube 57, which is an example of a flow path part, is connected to the relay apparatus 9 from the ink supply apparatus 4. The relay apparatus 9 includes a pump unit 59. The pump unit 59 pumps the inks contained in the ink containers 51 attached to the ink supply apparatus 4. Then, the pump unit 59 sends the inks pumped from the ink containers 51 to the recording head 19 via ink supply tubes 61. Through this, the inks contained in the ink containers 51 are supplied to the recording head 19 from the ink supply apparatus 4 via the relay apparatus 9. Then, the inks supplied to the recording head 19 are discharged as ink droplets through nozzles (not shown) pointing toward the recording medium P.

With the liquid ejection system 1 having the above-described configuration, the driving of the conveyance motor 13 is controlled by the control portion 11 so as to cause the conveyance apparatus 5 to intermittently convey the recording medium P in the Y axis direction, with the recording medium P facing the recording head 19. At this time, the control portion 11 controls the driving of the recording head 19 so as to cause ink droplets to be discharged at a predetermined position while controlling the driving of the carriage motor 45 so as to move the carriage 17 in a reciprocal manner along the X axis. Through this operation, dots are formed on the recording medium P, and recording is performed on the recording medium P based on recorded information such as image data.

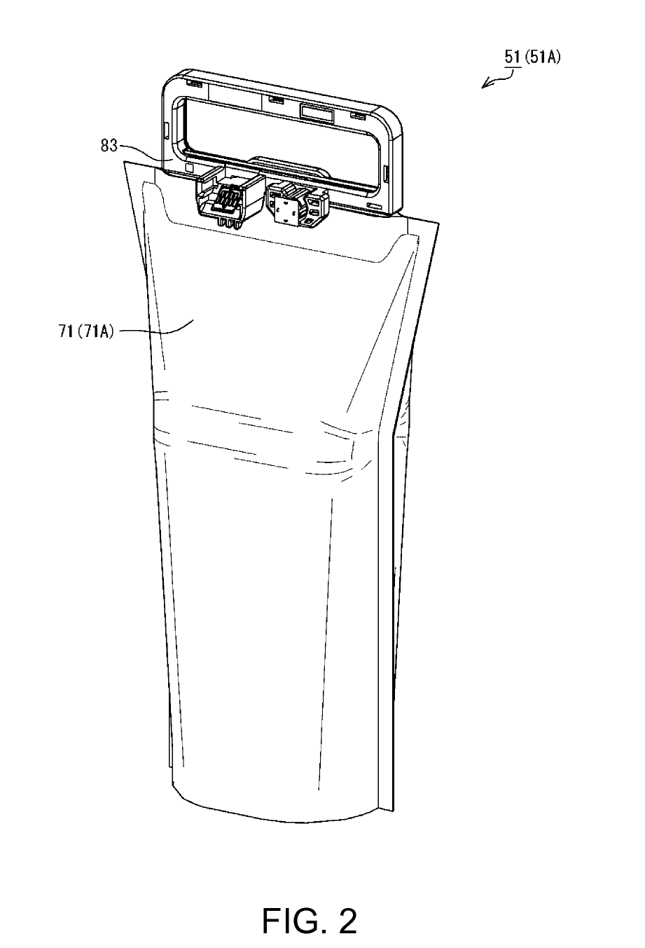

As shown in FIG. 2, the ink container 51 includes an ink bag 71, which is an example of a liquid containing portion, and a flow path unit 83. In the present embodiment, a plurality of types (six types) of ink containers 51 are used. Hereinafter, the six types of ink containers 51 will be respectively referred to as “ink container 51A”, “ink container 51B”, “ink container 51C”, “ink container 51D”, “ink container 51E”, and “ink container 51F” when it is necessary to make a distinction between the six types of ink containers 51. The six types of ink containers 51 are different from each other in terms of the configuration and dimensions of the ink bags 71.

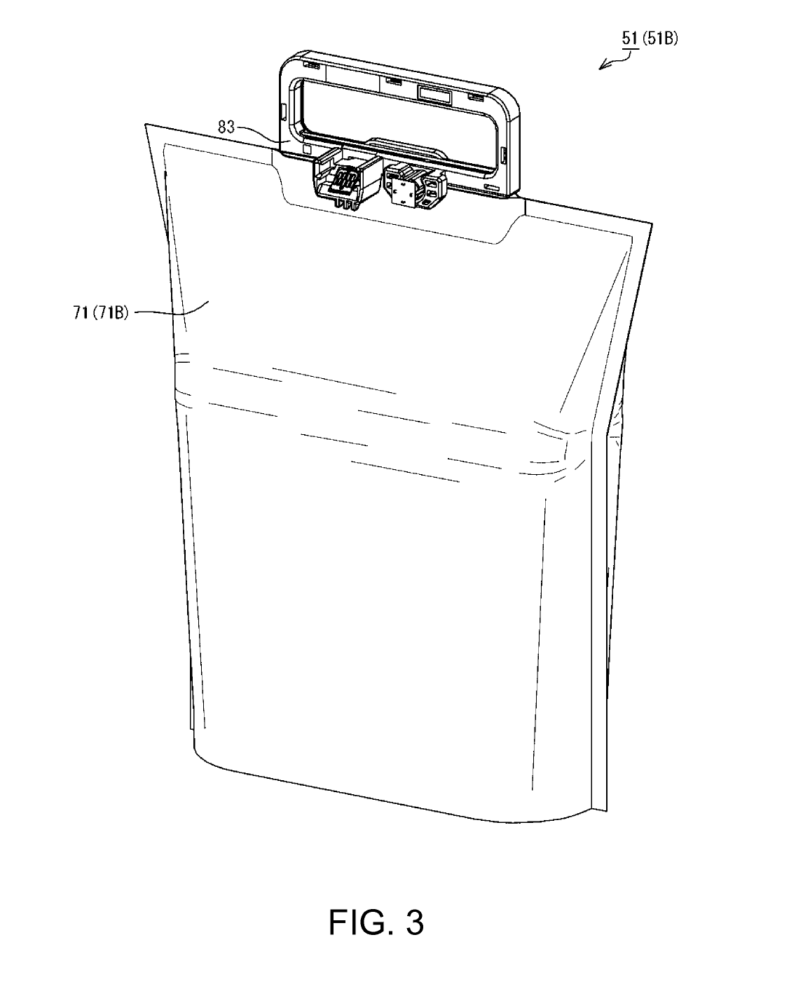

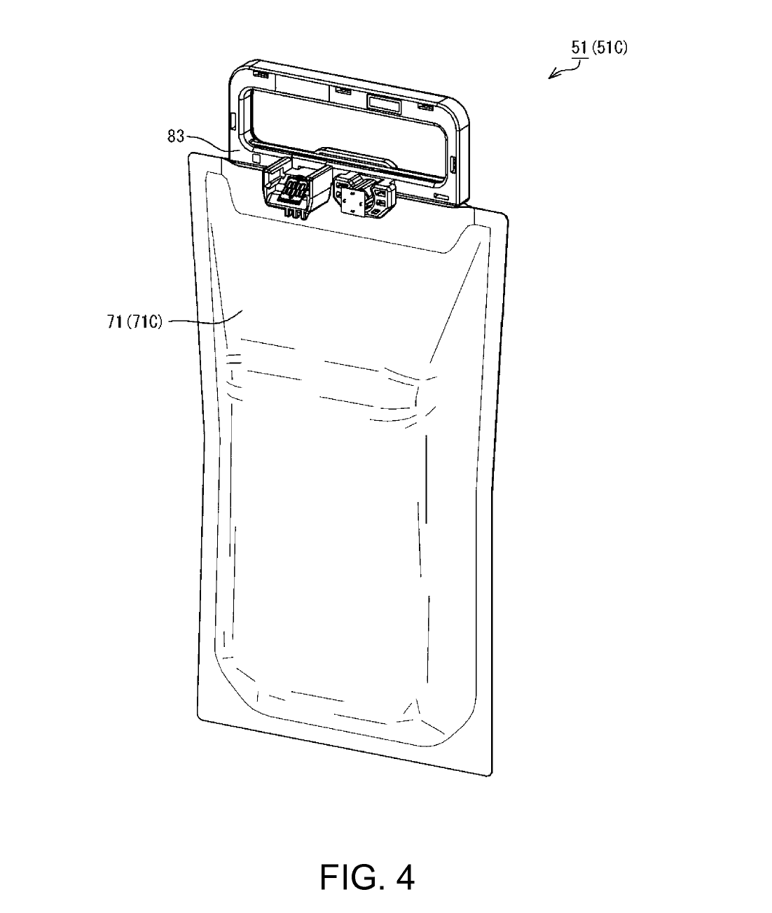

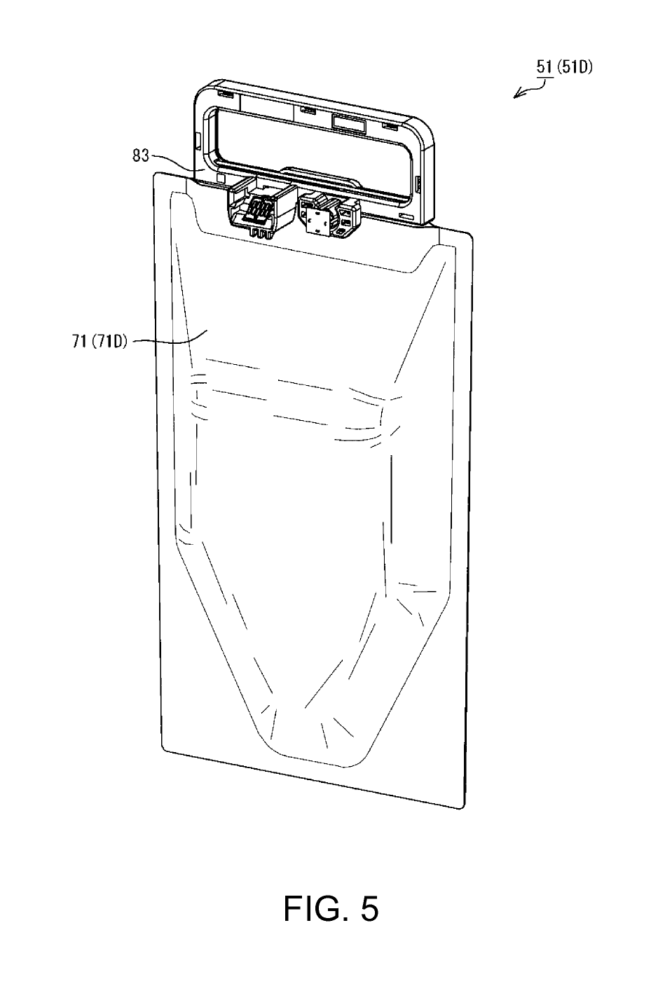

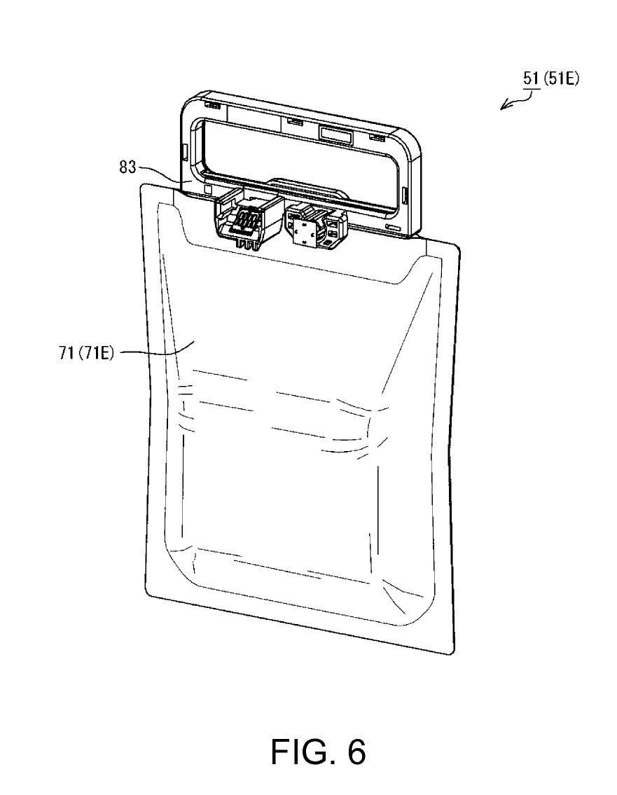

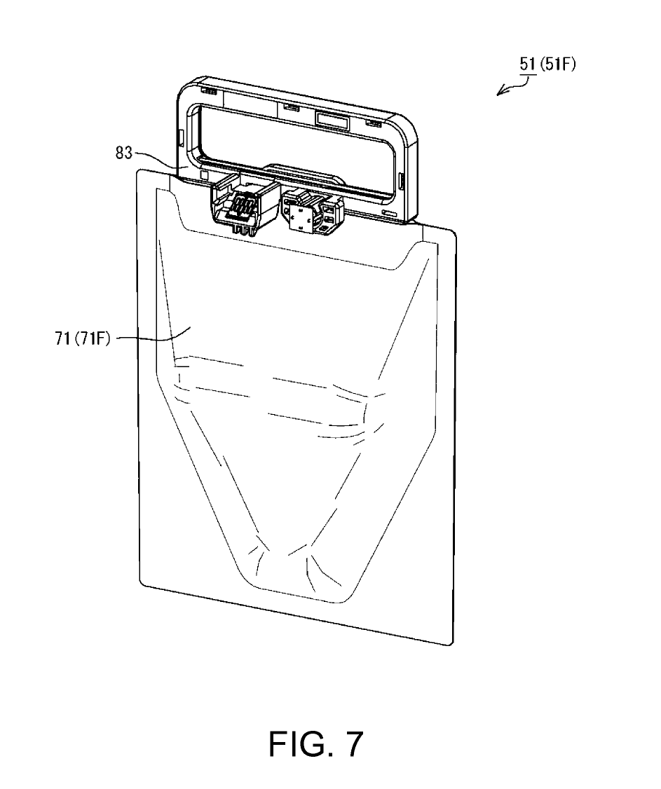

As shown in FIG. 2, the ink container 51A includes an ink bag 71A and a flow path unit 83. As shown in FIG. 3, the ink container 51B includes an ink bag 71B and a flow path unit 83. As shown in FIG. 4, the ink container 51C includes an ink bag 71C and a flow path unit 83. As shown in FIG. 5, the ink container 51D includes an ink bag 71D and a flow path unit 83. As shown in FIG. 6, the ink container 51E includes an ink bag 71E and a flow path unit 83. As shown in FIG. 7, the ink container 51F includes an ink bag 71F and a flow path unit 83. The six types of ink containers 51 have the same configuration except for the ink bags 71. Accordingly, in the following description, details of the configuration of the ink container 51A will be given as an example, and descriptions of the ink containers 51B to 51F are omitted.

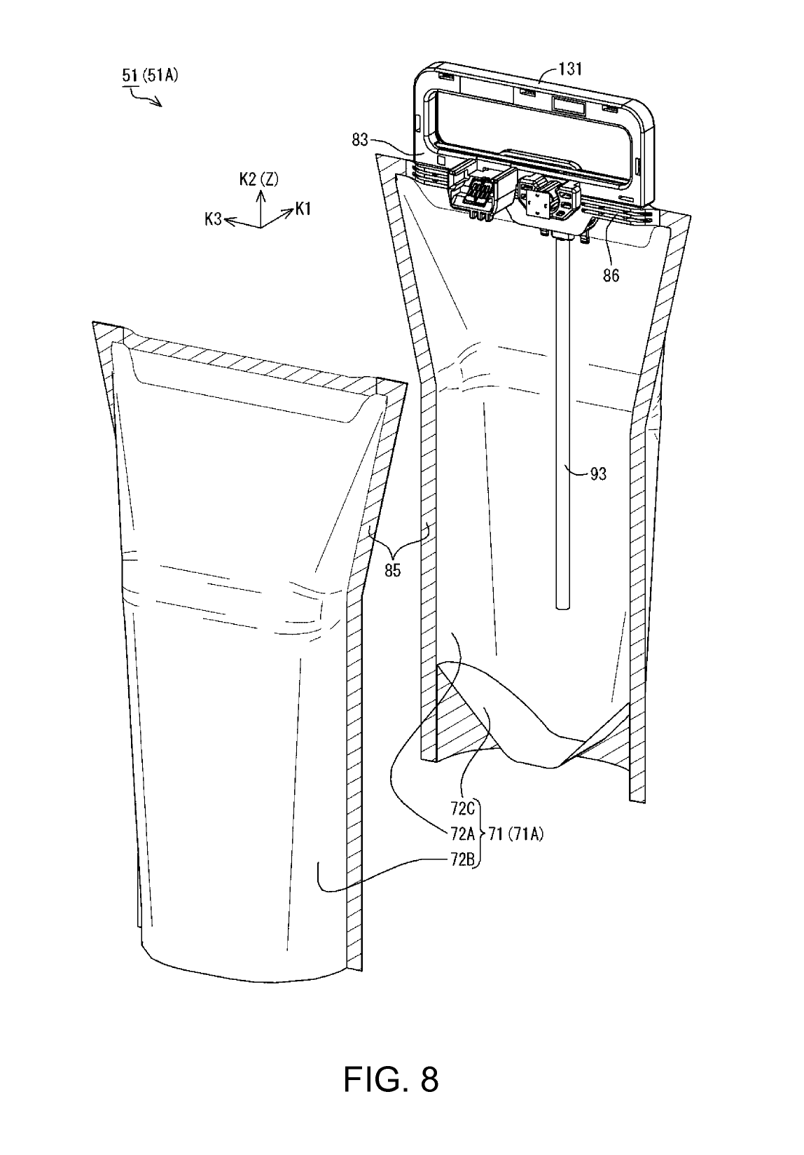

As shown in FIG. 8, the ink bag 71 includes at least two flexible film material sheets 72 (a film material sheet 72A and a film material sheet 72B). The ink bag 71A is composed of three mutually bonded film material sheets 72. Hereinafter, the three film material sheets 72 will be respectively referred to as “film material sheet 72A”, “film material sheet 72B”, and “film material sheet 72C” when it is necessary to make a distinction between the three film material sheets 72. The film material sheet 72A and the film material sheet 72B are bonded in a mutually facing relationship. In the ink container 51, the facing direction of two film material sheets 72 (the film material sheet 72A and the film material sheet 72B) will be referred to as “first direction K1”. Likewise, the direction in which a handle portion 131 (described later) of the flow path unit 83 protrudes from the ink bag 71 will be referred to as “second direction K2”. In the liquid ejection system 1, the second direction K2 corresponds to the Z axis direction. In addition, the direction that (perpendicularly) crosses both the first direction K1 and the second direction K2 will be referred to as “third direction K3”.

The film material sheet 72A and the film material sheet 72B are fused to each other at their rim regions 85 in a mutually overlapping relationship. The film material sheet 72C is interposed between the film material sheet 72A and the film material sheet 72B in the first direction K1. The rim of the film material sheet 72C is fused to the film material sheet 72A and the film material sheet 72B, with the rim being overlapped by the rim regions 85. Accordingly, the ink bag 71 is in the form of a bag having the film material sheet 72C as the bottom. Ink is contained in the ink bag 71. The ink bag 71 therefore functions as an ink containing portion for containing ink, which is an example of a liquid. In FIG. 8, the rim regions 85 are indicated by hatching in order to clearly illustrate the configuration. Also, FIG. 8 shows a state in which the film material sheet 72C is cut between the film material sheet 72A and the film material sheet 72B.

The flow path unit 83 is sandwiched between the film material sheet 72A and the film material sheet 72B at a part of the rim regions 85. At that part of the rim regions 85, the flow path unit 83 and the film material sheet 72A are fused to each other. Likewise, at that part of the rim regions 85, the flow path unit 83 and the film material sheet 72B are fused to each other. Accordingly, the part of the rim regions 85 where the flow path unit 83 is sandwiched between the film material sheet 72A and the film material sheet 72B serves as a bonding portion between the ink bag 71 and the flow path unit 83. The flow path unit 83 includes a fusing portion 86. With the fusing portion 86 being sandwiched by the film material sheet 72A and the film material sheet 72B, the film material sheet 72A and the film material sheet 72B are fused to the fusing portion 86. As a result of the film material sheet 72A, the film material sheet 72B and the flow path unit 83 being bonded to each other, the ink bag 71 having the film material sheet 72C as the bottom is formed.

The film material sheet 72A, the film material sheet 72B and the film material sheet 72C can be made of materials such as polyethylene terephthalate (PET), nylon and polyethylene. A laminate structure may be used in which film sheets made of such materials are laminated. The laminate structure may include, for example, an outer layer made of PET or nylon having excellent impact resistance and an inner layer made of polyethylene having excellent ink resistance. Furthermore, it is also possible to use, for example, a film having a layer formed by vapor deposition using aluminum or the like. With this configuration, gas barrier properties can be enhanced. The ink bag 71B of the ink container 51B (FIG. 3) is also composed of three film material sheets 72, as with the ink bag 71A. The ink bag 71A and the ink bag 71B have a so-called “pouch type” form. In the four ink containers 51C to 51F (FIGS. 4 to 7), the ink bags 71 are each composed of two film material sheets 72 (a film material sheet 72A and a film material sheet 72B). The four ink bags 71C to 71F have a so-called “pillow type” form.

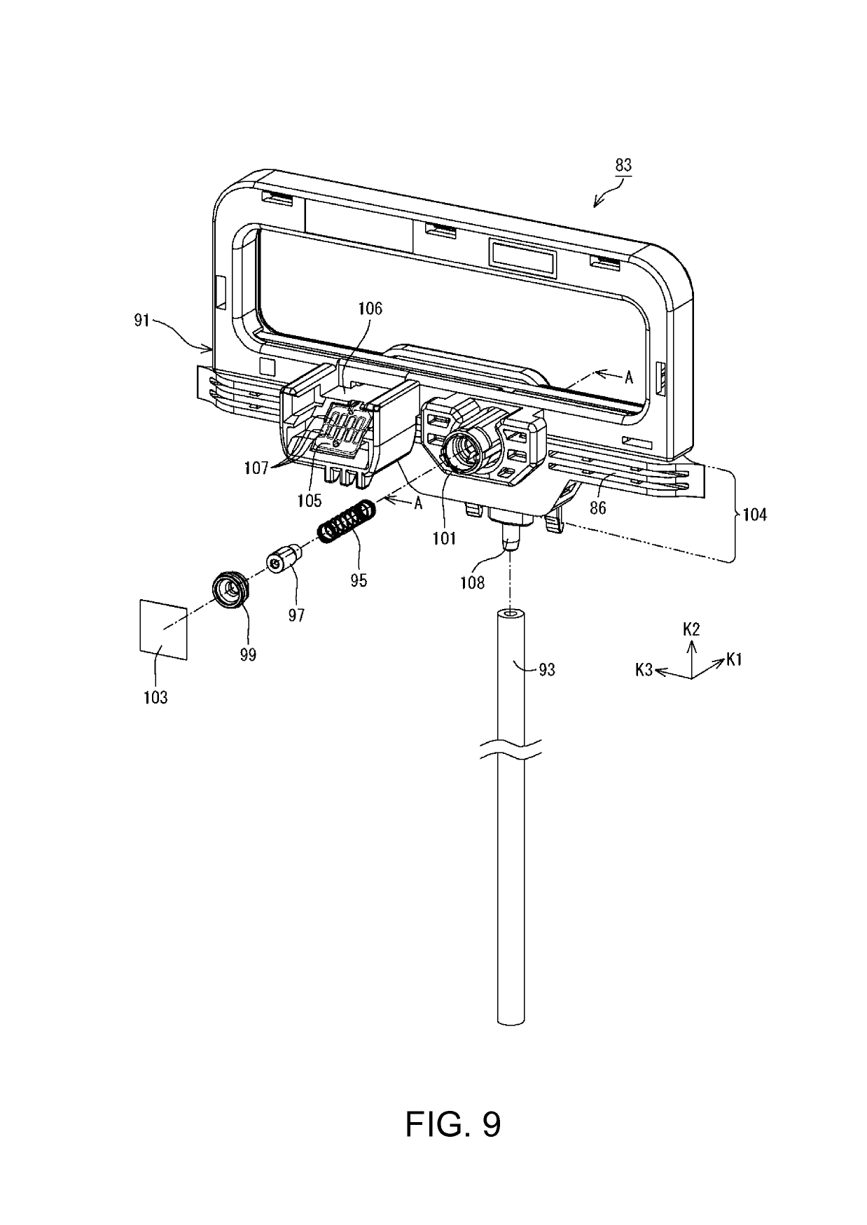

As shown in FIG. 9, the flow path unit 83 includes a flow path member 91, a tube 93, a spring 95 constituting a valve, a stopper (valve body) 97, and a gasket (valve seat) 99. The flow path member 91 includes a supply portion 101, which is an example of a liquid outlet portion. The supply portion 101 allows the inside and the outside of the ink bag 71 (FIG. 8) to be in communication with each other. The flow path member 91 functions as a liquid withdrawing portion that withdraws ink, which is an example of a liquid, from the inside to the outside of the ink bag 71. The spring 95, the stopper 97 and the gasket 99 are contained in the supply portion 101 in this order. The supply portion 101 is closed by a film 103 before the ink container 51 is attached to the ink supply apparatus 4. By doing so, the inside of the ink bag 71 can be kept hermetically sealed.

The flow path unit 83 also includes a circuit board 105, which is an example of an electric connection portion. The flow path member 91 includes a board installation portion 106. The board installation portion 106 is provided on the supply portion 101 side of the flow path member 91. In other words, the supply portion 101 and the board installation portion 106 are provided on the same side of the flow path member 91. The circuit board 105 is provided in the board installation portion 106. The circuit board 105 includes a plurality of terminal portions 107. The plurality of terminal portions 107 are directed away from the flow path member 91. On a side of the circuit board 105 that is opposite to the side on which the terminal portions 107 are provided, a storage device (not shown) such as a non-volatile memory is provided. At least one of the plurality of terminal portions 107 is electrically connected to the storage device. In a state in which the ink container 51 is attached to the ink supply apparatus 4, at least one of the plurality of terminal portions 107 is in contact with a contact mechanism (not shown) provided in the case 53 (FIG. 1). The contact mechanism is electrically connected to the control portion 11 via the flexible cable 31 (FIG. 1). As a result of the contact mechanism and the storage device of the ink container 51 being electrically connected to each other via the circuit board 105, various types of information can be transmitted between the control portion 11 and the storage device of the ink container 51.

The flow path member 91 includes a base 104. A side surface of the base 104 is set as the fusing portion 86. The flow path member 91 includes an introduction inlet 108. The introduction inlet 108 is provided on the base 104, and extends along the Z axis (K2). The introduction inlet 108 protrudes in the −Z axis direction from the base 104. The introduction inlet 108 communicates with the inside of the ink bag 71 so as to introduce the ink contained in the ink bag 71 to the supply portion 101. The supply portion 101 extends in a direction that crosses the extension direction of the introduction inlet 108, or in other words, in a direction that crosses the Z axis. The supply portion 101 is also provided on the base 104, and protrudes in a direction that crosses the Z axis direction from the base 104. The tube 93 is connected to the introduction inlet 108. Then, as shown in FIG. 8, the tube 93 is inserted into the ink bag 71. With the tube 93, an introduction path to the introduction inlet 108 is extended toward the bottom of the ink bag 71.

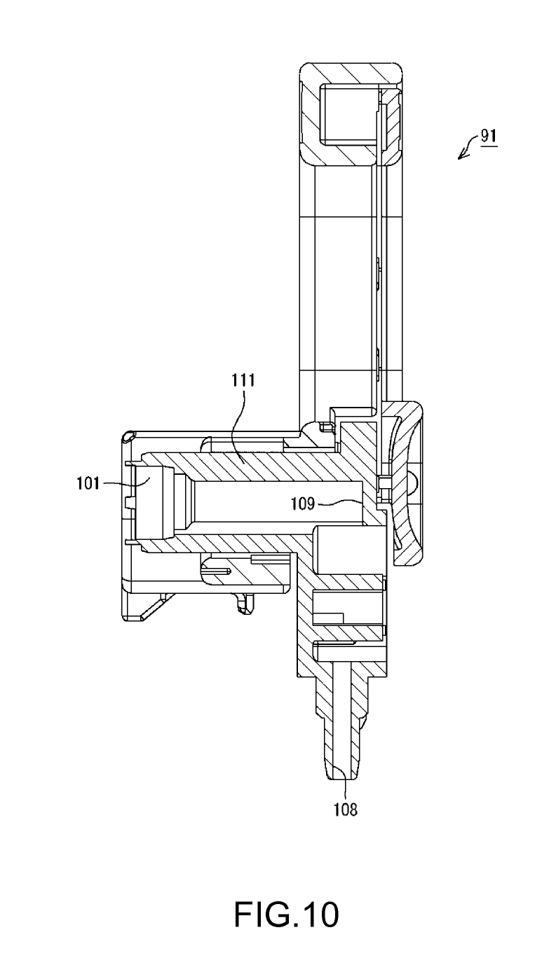

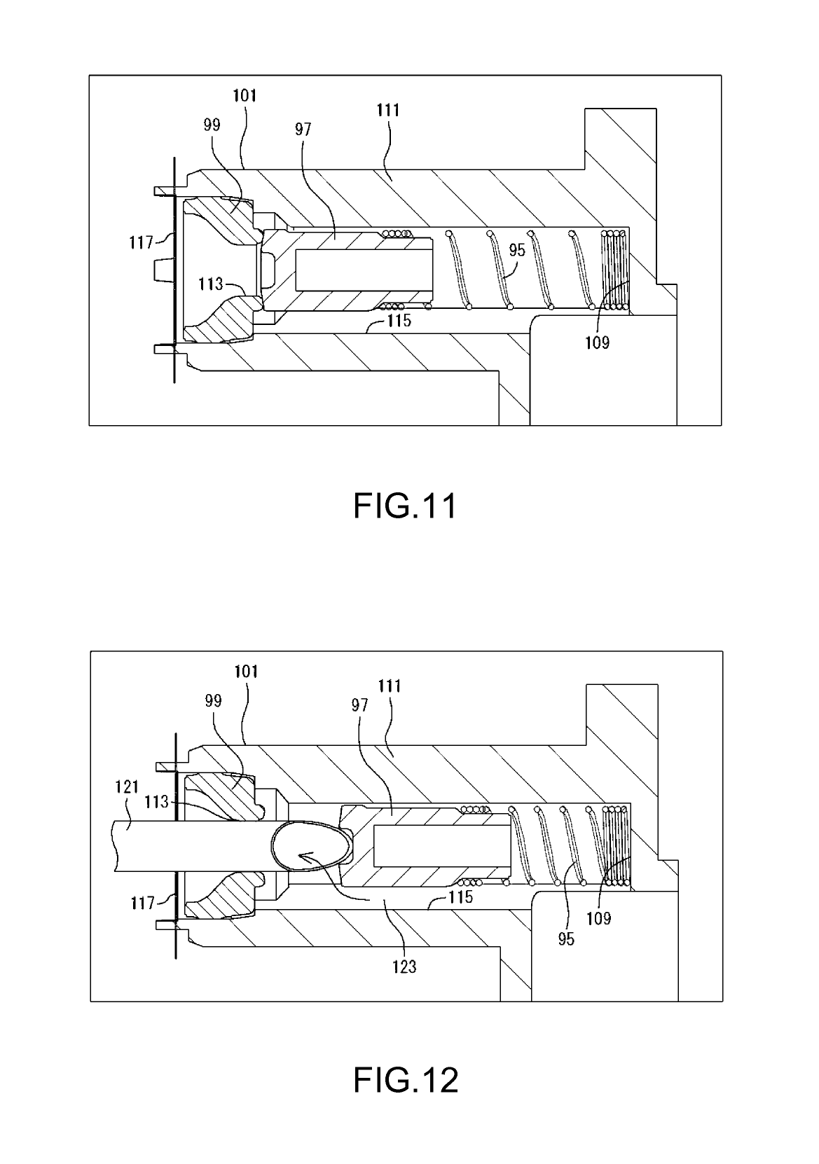

As shown in FIG. 10, within the flow path member 91, the supply portion 101 is in communication with the introduction inlet 108. The supply portion 101 includes a bottom 109 and a side wall 111. The side wall 111 surrounds the bottom 109. The region surrounded by the side wall 111 functions as a supply inlet that supplies the ink contained in the ink bag 71 to the outside. As shown in FIG. 11, within the supply portion 101, the spring 95, the stopper 97 and the gasket 99 are contained. The spring 95 is interposed between the bottom 109 of the supply portion 101 and the stopper 97. The stopper 97 is interposed between the spring 95 and the gasket 99. Accordingly, the stopper 97 is impelled toward the gasket 99 by the spring 95.

The gasket 99 is made of, for example, an elastic body such as rubber or elastomer. The gasket 99 is press fitted into the supply portion 101. The gasket 99 includes an opening 113. The stopper 97 is impelled toward the gasket 99, with the stopper 97 overlapping the opening 113 of the gasket 99. Accordingly, the opening 113 of the gasket 99 is closed by the stopper 97. A space is provided between the stopper 97 and the supply portion 101. A space is also provided between the spring 95 and the supply portion 101. Accordingly, the stopper 97 and the spring 95 can be shifted within the supply portion 101 along the extension direction of the supply portion 101.

Within the supply portion 101, a groove 115 is provided. The groove 115 extends along the extension direction of the supply portion 101 from a terminal end 117 side of the supply portion 101 toward the bottom 109. The groove 115 extends from the bottom 109, through the spring 95, and toward the gasket 99 side. The groove 115 is provided so as to form a recess from the inner wall toward the outer wall of the supply portion 101. Accordingly, in a state in which the stopper 97 is contained in the supply portion 101, the space surrounded by the stopper 97 and the groove 115 can be used as an ink flow path.

When the ink container 51 is attached to the ink supply apparatus 4 (FIG. 1), as shown in FIG. 12, a supply needle 121 is inserted into the opening 113 of the gasket 99. At this time, the stopper 97 is pressed by the supply needle 121 and shifted toward the bottom 109 side. The supply needle 121 is hollow. Also, the supply needle 121 is in communication with the ink supply tube 57. Accordingly, as indicated by the arrow shown in the drawing, ink can be supplied to the ink supply tube 57 (FIG. 1) from a flow path 123 surrounded by the groove 115 and the stopper 97 via the supply needle 121. The supply needle 121 is provided within the case 53 of the ink supply apparatus 4.

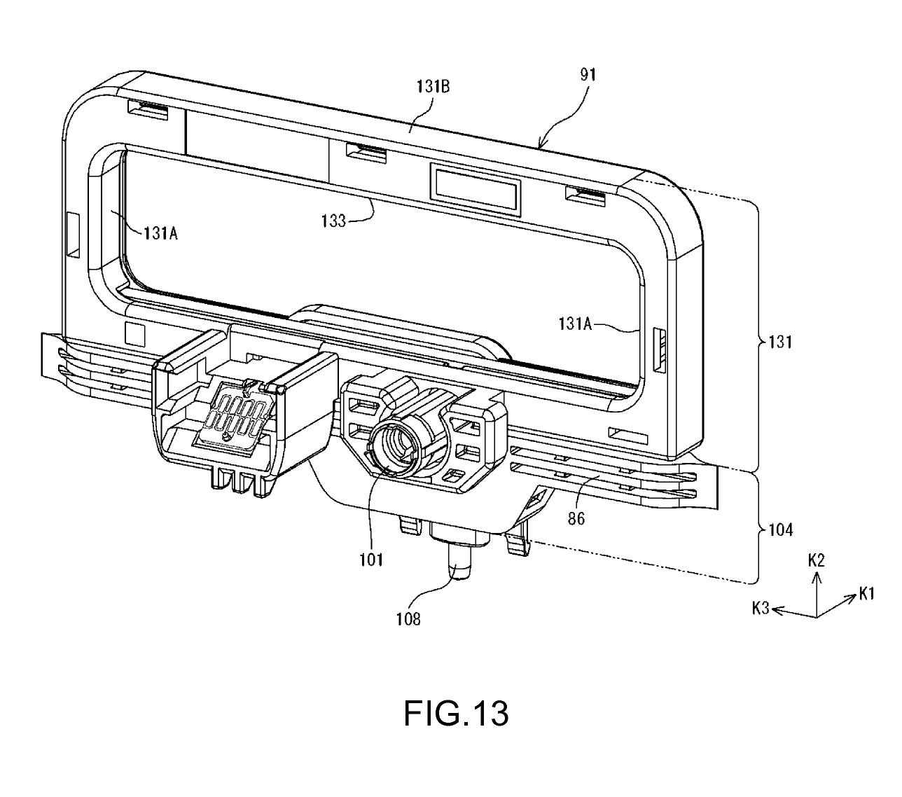

As shown in FIG. 13, the flow path member 91 includes a handle portion 131. The handle portion 131 is provided on the base 104. Accordingly, the handle portion 131 is positioned at an end portion of the ink bag 71. The handle portion 131 protrudes in the +Z axis direction from the base 104, or in other words, protrudes from the base 104 so as to be away from the introduction inlet 108, or in short, away from the ink bag 71. Accordingly, the handle portion 131 protrudes outward from the ink bag 71. The handle portion 131 extends along the extension direction of the base 104. The handle portion 131 includes two leg portions 131A and a grip portion 131B. The two leg portions 131A are provided on the base 104, and extend in the +Z axis direction from the base 104. The two leg portions 131A are also referred to as “connecting portions” because they are connected to the base 104.

The two leg portions 131A are spaced apart from each other in the extension direction of the base 104. The grip portion 131B is provided on the +Z axis direction side of the two leg portions 131A, or in other words, on a side opposite to the base 104 side of the two leg portions 131A. The grip portion 131B extends along the extension direction of the base 104. The two leg portions 131A are connected to the grip portion 131B. From another perspective of view, it can be seen that an opening 133 is formed in the handle portion 131. The opening 133 passes through the handle portion 131 in the first direction K1. The opening 133 is a region surrounded by the base 104, the two leg portions 131A and the grip portion 131B. With the configuration described above, an operator can hold the grip portion 131B by inserting the fingers between the grip portion 131B and the base 104. That is, the operator can hold the grip portion 131B by inserting the fingers into the opening 133. Then, the operator can carry the ink container 51 by holding the grip portion 131B.

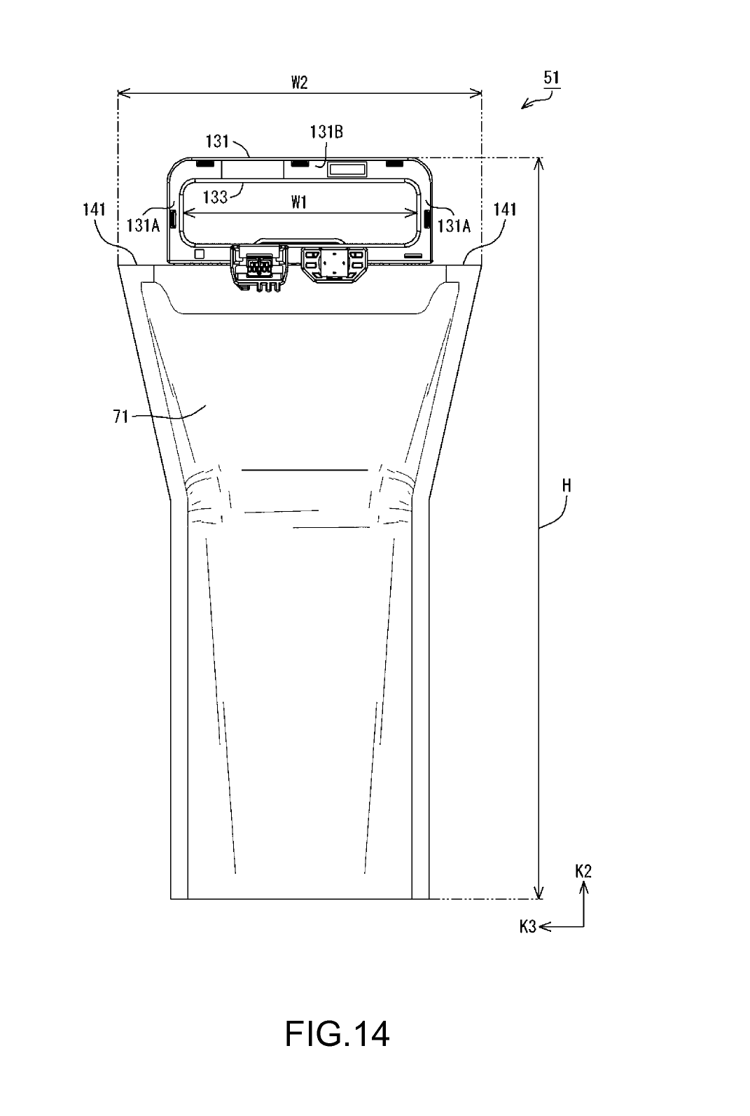

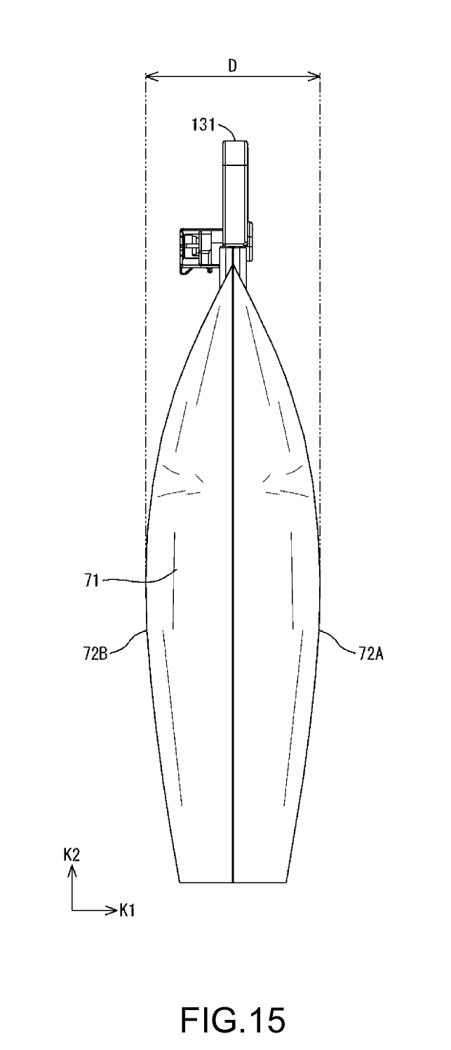

A description is now given of dimensions of the ink container 51. As shown in FIG. 14, in the ink container 51, a dimension in the third direction K3 of the opening 133 of the handle portion 131 is defined as “opening dimension W1”. In the ink container 51, a width dimension in the third direction K3 of the ink bag 71 is defined as “width dimension W2”. In the second direction K2, a dimension including the ink bag 71 and the handle portion 131 is defined as “height dimension H” of the ink container 51. Likewise, as shown in FIG. 15, in the ink container 51, a thickness dimension in the first direction K1 of the ink bag 71 is defined as “thickness dimension D”. The thickness dimension D is a distance in the first direction K1 between two film material sheets 72B and 72A. The thickness dimension D is a thickness dimension of a maximally expanded portion of the ink bag 71, with ink being contained in the ink bag 71. Preferred ranges of the dimensions defined above are shown in Table 1 given below. Likewise, examples of set values for the dimensions of the ink containers 51A to 51F are shown in Table 2 given below.

TABLE 1

| | Dimensions | | | |
|---|---|---|---|---|
| | Opening | Width | Height | Thickness |
| | dimension W1 | dimension W2 | dimension H | dimension D |
| Preferred | 80 to 120 | 50 to 300 | 50 to 400 | 10 to 150 |
| range | | | | |
| (mm) | | | | |

TABLE 2

| | Set values for dimensions (mm) | | | |
|---|---|---|---|---|
| | Opening | | | Thickness |
| | dimension | Width | Height | dimension |
| | W1 | dimension W2 | dimension H | D |
| Ink container 51A | 100 | 150 | 300 | 75 |
| Ink container 51B | 100 | 240 | 300 | 85 |
| Ink container 51C | 100 | 150 | 290 | 55 |
| Ink container 51D | 100 | 150 | 295 | 35 |
| Ink container 51E | 100 | 150 | 220 | 30 |
| Ink container 51F | 100 | 150 | 225 | 20 |

A preferred range of the opening dimension W1 ranges from 80 mm to 120 mm. If the opening dimension W1 is within the range, the fingers can be easily inserted into the opening 133 of the handle portion 131. If the opening dimension W1 is below the range, it becomes difficult to insert the fingers into the opening 133. If the opening dimension W1 is above the range, the holding position with respect to the grip portion 131B easily varies significantly.

A preferred range of the width dimension W2 ranges from 50 mm to 300 mm. If the width dimension W2 is within the range, deformation of the ink bag 71 can be reduced without significantly compromising the volume efficiency of the ink bag 71. If the width dimension W2 is below the range, the volume efficiency of the ink bag 71 is likely to be low. If the width dimension W2 is above the range, for example, in the case where the handle portion 131 is held so as to lift the ink container 51, the ink container 51 is likely to undergo deformation. At this time, deformation is likely to occur intensively in, in particular, shoulder portions 141 of the ink container 51 shown in FIG. 14. The shoulder portions 141 are a part of the rim region 85 (FIG. 8) of the ink bag 71 serving as a boundary with a region overlapping the fusing portion 86 of the flow path unit 83. If the width dimension W2 is above the range, in the case where the handle portion 131 is held so as to lift the ink container 51, the shoulder portions 141 of the ink bag 71 are downwardly pulled. Accordingly, deformation is likely to occur intensively in the shoulder portions 141 of the ink bag 71.

A preferred range of the height dimension H ranges from 50 mm to 400 mm. If the height dimension H is within the range, the ink container 51 can be easily handled. If the height dimension H is below the range, the amount of ink that can be contained in the ink bag 71 decreases. If, on the other hand, the height dimension H is above the range, for example, in the case where the handle portion 131 is held so as to lift the ink container 51 from the floor, it becomes difficult to handle the ink container 51 because the ink container 51 is suspended closer to the floor. Also, if the height dimension H is above the range, the ink supply apparatus 4 is likely to be large, and thus the printer 3 is likely to be large.

A preferred range of the thickness dimension D ranges from 10 mm to 150 mm. If the thickness dimension D is within the range, the ink contained in the ink bag 71 can be effectively used without significantly compromising the volume efficiency of the ink bag 71. If the thickness dimension D is below the range, the volume efficiency of the ink bag 71 is likely to be low. If the thickness dimension D is above the range, unused ink that is not supplied (fails to be supplied) when the ink contained in the ink container 51 is supplied from the ink supply apparatus 4 to the printer 3 after the ink container 51 is attached to the ink supply apparatus 4 is likely to remain in the ink bag 71. As a result, it becomes difficult to increase the amount of ink contained in the ink bag 71 that can be effectively used.

Also, in the ink container 51, it is preferable that the film material sheets 72 have a thickness within a range from 0.05 mm to 0.5 mm. If the film material sheets 72 have a thickness within a range from 0.05 mm to 0.5 mm, the volume of ink contained in the ink bag 71 can be easily ensured without compromising the strength of the ink bag 71. If the film material sheets 72 have a thickness below the range, the strength of the ink bag 71 is likely to be low. If the film material sheets 72 have a thickness above the range, the flexibility of the ink bag 71 is likely to be low, and the ink bag 71 is less likely to expand, and thus the volume of ink contained in the ink bag 71 is likely to be low.

What is claimed is:

1. A liquid container that is capable of being attached to and detached from a liquid supply apparatus that supplies a liquid to a liquid ejection apparatus, the liquid container comprising:
a liquid containing portion that includes at least two flexible film sheets bonded in a mutually facing relationship and can contain a liquid between the at least two film sheets; and
a handle portion that is positioned at an end portion of the liquid containing portion and protrudes outward from the liquid containing portion,
wherein the handle portion includes an opening formed so as to pass through in a first direction that is a direction in which the at least two film sheets face each other,
in a third direction that is a direction that crosses the first direction and a second direction that is a direction in which the handle portion protrudes outward from the liquid containing portion, the opening has a dimension within a range from 80 mm to 120 mm, and
the liquid containing portion has a width dimension in the third direction within a range from 50 mm to 300 mm.

2. A liquid container that is capable of being attached to and detached from a liquid supply apparatus that supplies a liquid to a liquid ejection apparatus, the liquid container comprising:
a liquid containing portion that includes at least two flexible film sheets bonded in a mutually facing relationship and can contain a liquid between the at least two film sheets; and
a handle portion that is positioned at an end portion of the liquid containing portion and protrudes outward from the liquid containing portion,
wherein in a second direction that is a direction in which the handle portion protrudes outward from the liquid containing portion, a dimension including the liquid containing portion and the handle portion is within a range from 50 mm to 400 mm.

3. A liquid container that is capable of being attached to and detached from a liquid supply apparatus that supplies a liquid to a liquid ejection apparatus, the liquid container comprising:
a liquid containing portion that includes at least two flexible film sheets bonded in a mutually facing relationship and can contain a liquid between the at least two film sheets; and
a handle portion that is positioned at an end portion of the liquid containing portion and protrudes outward from the liquid containing portion,
wherein when a direction in which the at least two film sheets face each other is defined as a first direction, in a state in which the liquid containing portion contains a liquid, a distance in the first direction between the at least two film sheets of a maximally expanded portion of the liquid containing portion is within a range from 10 mm to 150 mm.

4. The liquid container according to claim 1,
wherein the film sheets have a thickness within a range from 0.05 mm to 0.5 mm.
